(19) United States
(12) Patent Application Publication
(10) Pub. No.: US 2007/0183944 A1
(43) Pub. Date: Aug. 9, 2007

(54) Non-thermal plasma reactor

(76) Inventor: James Timothy Shawcross, Charlbury (GB)

Correspondence Address: LAW OFFICES OF WILLIAM H. HOLT, 12311 HARBOR DRIVE, WOODBRIDGE, VA, 22192, US

(21) Appl. No.: 10/591,794

(22) PCT Filed: Mar. 8, 2005
(86) PCT No.: PCT/GB05/00882

§ 371 Date: Apr. 19, 2007

(30) Foreign Application Priority Data
Mar. 9, 2004 (GB) 0405185.0
Jan. 27, 2005 (GB) 0501541.7

(51) Int. Cl. B01J 19/08

(52) U.S. Cl. 422/186.04

(57) ABSTRACT

A non-thermal plasma reactor for the treatment of a gaseous medium comprising a plurality of double-sided filter elements in a stack, the elements being connectable alternately to high voltage and earth, and provided with a dielectric barrier between successive filter elements wherein the gaseous medium is constrained to flow into the filter elements.

The present invention relates to a non-thermal plasma reactor comprising filter elements for the removal of particulates including carbonaceous particulates or soot from gases and in particular for the treatment of gaseous media such as exhaust gases from an internal combustion engine. Such products are encountered in the exhausts of internal combustion engines and effluent gases from incineration or other industrial processes, such as from the pharmaceutical, food-processing, paint manufacturing, dye manufacturing, textiles and printing industries. Coal-fired power stations and gas turbines also produce effluent gases which can be treated in this way.

There is a requirement for improved methods of trapping and removing particulates from exhaust gas streams. U.S. Pat. Nos. 5,853,437 and 6,063,150 disclose a system where particulates are trapped on a filter. The filter is then regenerated by heating the filter to burn off the particulates. U.S. Pat. No. 6,517,786 discloses a reactor where a plasma is used to regenerate the filter. One of the main challenges with achieving highly efficient filtration of particulates from gas streams is minimizing the associated pressure drop across the filter caused by the build up of particulates, by successfully regenerating the filter, before the filter clogs up. When a filter is incorporated into a non-thermal plasma reactor the plasma may be generated continuously or intermittently when regeneration is required. The combination of a plasma with a substrate (for example, a filter material) that acts as a particulate trap is known.

U.S. Pat. No. 6,517,786 discloses a non-thermal plasma reactor for the decomposition of pollutants which comprises a porous electrode arranged along the direction of flow of gas entering the reactor. The waste gas treated in the reactor is constrained to pass through the porous electrode which is designed so as to be permeable to gaseous components but acts as a filter for soot particles.

Reactors of this type have the potential to provide a significant reduction in the amount of particulate pollutants present in a gaseous medium. However, in practice a reactor of this type suffers from problems with back-pressure primarily due to the low surface area per volume of reactor. In order for the reactor to be able to treat all of the exhaust gas from, for example, a car, the reactor of the type disclosed in U.S. Pat. No. 6,517,786 has to be large in order to provide a high enough surface area of porous electrode. This typically results in reactors which are too large to be of practical use.

The present invention aims to address this problem and seeks to provide a non-thermal plasma reactor which has a higher surface area of filter for a given volume of reactor.

Accordingly the present invention provides a non-thermal plasma reactor for the treatment of a gaseous medium comprising
a plurality of double-sided filter elements in a stack, the elements being connectable alternately to high voltage and earth, and
provided with a dielectric barrier between successive filter elements
wherein the gaseous medium is constrained to flow into the filter elements.

The reactor comprises a plurality of filter elements such as two, three, four, five or more filter elements. Preferably the reactor comprises a multiplicity of filter elements such as ten, fifteen, twenty, thirty or more filter elements. The number of filter elements required in a particular reactor will vary depending on the size of the elements, the space restraints on the size of the reactor, the frequency of regeneration of the filters and type of gaseous medium to be treated.

The filter elements are double-sided so as to maximize the surface area of filter in the plasma volume of the reactor. The reactor is typically arranged so that the plasma forms over as large a proportion of the filter area as possible. In one embodiment, the filters at either end of the stack are single-sided and the outer faces of these filters are solid as these faces of the filter elements will not be remediated by plasma.

The filter elements comprise a conducting material. The filter elements act as the electrodes of the non-thermal plasma reactor and the elements as a whole are conductors. In a preferred embodiment all the components of the filter elements are conductors. The filter elements comprise a filter material which traps particulates but is permeable to gas. Typically, as large a proportion as possible of the filter element is made of the filter material. However, parts of the filter element may be solid in order to provide any necessary stiffness to the element as a whole. Parts of the filter element may be used to connect filter elements to one another or to the reactor. For example, an annular filter element may comprise a central part or ring which may be referred to as a hub. The filter element may comprise woven metal filter cloth, metal fibres, sintered metal fibre material or sintered metal powder material. One example of woven metal filter cloth is that made by G Bopp & Co. Examples of sintered metal fibre materials are those obtainable from Porvair Filtration Group Limited—Microfiltrex (Fareham, UK) and Bekhaert (Belgium) made of stainless steel, Monel®, Inconel®, Hastelloy® and Fecralloy®. Stainless steel discs made by sintering powder are available from Martin Kurz & Co Inc sold under the name Dynapore™ SPM™ and from Porvair Filtration Group Limited—Microfiltrex. Stainless steel is in general a preferred metal for the filter. Hastelloy® and Fecralloy® are particularly preferred materials as well. Filters such as those described in WO 98/52671 are suitable for use in the present invention.

In a preferred embodiment the filter elements are hollow.

The filter elements are typically substantially flat. In a preferred embodiment, the filters are annular, preferably the filters are flat and annular. In another embodiment, the filters are rectangular, square, quadrilateral or in the shape of another polygon such as a pentagon or hexagon.

The filter elements are attached to the structure of the reactor in such a way that the space inside each filter element communicates only with a space that is outside the reactor. In this way gas that passes into the space inside the filter element can leave the reactor.

For example, where the filter elements are annular in shape, the outer can of the reactor is typically cylindrical. Gaseous medium enters the reactor and flows into the filter element. The filter elements may be connected together such that the space inside each filter element communicates with a cylindrical chamber in the centre of the reactor which is divided from the reactor space. Thus the gaseous medium must flow into the filter elements in order to leave the reactor through the central cylindrical chamber.

Where the filter elements are in the form of square, rectangular or other polygonal plates, the elements may all be connected to one wall of the reactor such that gaseous medium flowing into the reactor space leaves the reactor through that wall of the reactor.

The filter elements are connectable to earth and high voltage by any suitable means. In one embodiment, the connections to earth and high voltage are within the filter elements, for example inside the hub of annular filter elements. In another embodiment, some of the connections, such as the earth connections, may be achieved by connecting the filter elements to the outer can of the reactor.

The dielectric barrier is a layer of material arranged to provide for a non-thermal plasma of the type referred to as a dielectric barrier type discharge, when an electrical power supply is connected to the filter elements to apply an electrical potential across the space between adjacent filter elements. The dielectric material may be a ceramic material such as alumina or silica or any other ceramic material. Quartz, glass, glass-ceramic and a micaceous glass such as MICATHERM™ are also possible materials.

Typically the top and bottom filter elements in the stack are connected to earth.

In one embodiment, the space between the filter elements is empty. The gaseous medium passes though the space but there is no filling material or catalytic material in the space between the electrodes for it to pass through or over.

In another embodiment some or all of the space between the filter elements is filled by a filling material. The filling material is any material which improves the performance of the reactor. It must be able to withstand the temperatures at which the reactor is operating. The filling material is a dielectric material. Suitable materials include ceramic materials such as, but not exclusively, oxides for example aluminas, titanias, silicas, zirconia, glasses, glass ceramics, mixed oxides, complex oxides and metal doped oxides. An example of the latter is silver-doped alumina. The filling can be in the form of spheres, pellets, extrudates, fibres, blanket, felt, sheets, wafers, frits, coils, foams, graded foams, membrane, ceramic honeycomb monolith or granules.

The filling material may act as a further filter material, or as a support for a catalyst, or as a catalyst itself or a mixture thereof. Combinations of different catalysts can be used. Vanadates such as metavanadates and pyrovanadates and perovskites are examples of catalysts. Zeolites and metal containing zeolites have a catalytic function. Examples of zeolites are ZSM-5, Y, beta, mordenite and examples of metals that can be used in metal containing zeolites are copper, silver, iron, cobalt. Promoting cations such as cerium and lanthanum can be present in the zeolite composition. A preferred catalyst is silver doped alumina. The catalyst can be in the form of any of the shapes mentioned above for the filling material or as a coating on or contained within a dielectric material. A preferred filling material is a dielectric fibre material such as Saffil (95% by weight alumina: 5% by weight silica) in the form of, for example, a blanket or vacuum formed shape.

The filling material may be coated with a catalyst such as a catalyst for the conversion of NO to NO₂ or NOₓ (NO and NO₂) to N₂ in order to improve the processing of noxious exhaust gases in the gaseous medium. The filling material or the filter element may be coated with a catalyst for the conversion of carbon to carbon monoxide and/or carbon dioxide.

The plasma may be generated continuously or intermittently while gaseous medium passes through the reactor. Two reactors may also be connected in parallel and each reactor has gas passed through it in turn. A plasma may then be generated in each reactor either intermittently, for example when the gaseous medium for treatment is passing through the other reactor or continuously. Gaseous medium may also be passed through two reactors in parallel simultaneously.

The present invention also provides a vehicle such as a car, van, lorry or tank, comprising a reactor according to the present invention. The present invention also provides a ship comprising a reactor according to the present invention. The present invention also provides a power generation unit such as a combustion engine generator e.g. Genset, comprising a reactor according to the present invention.

The present invention also provides a method for treating a gaseous medium to remove particulates comprising passing the gaseous medium through a reactor according to the present invention and generating a plasma in the reactor intermittently or continuously. The filter elements in the reactor are regenerated by the plasma. Thus, the plasma is generated for as much time as necessary to regenerate the filter elements.

The present invention provides the use of a reactor according to the present invention for the removal of particulates from a gaseous medium. In particular the present invention provides the use of a reactor according to the present invention in a vehicle, power station or other situation where exhaust or effluent gases are produced.

Specific constructions of reactors embodying the invention will now be described by way of example and with reference to the drawings filed herewith, in which:

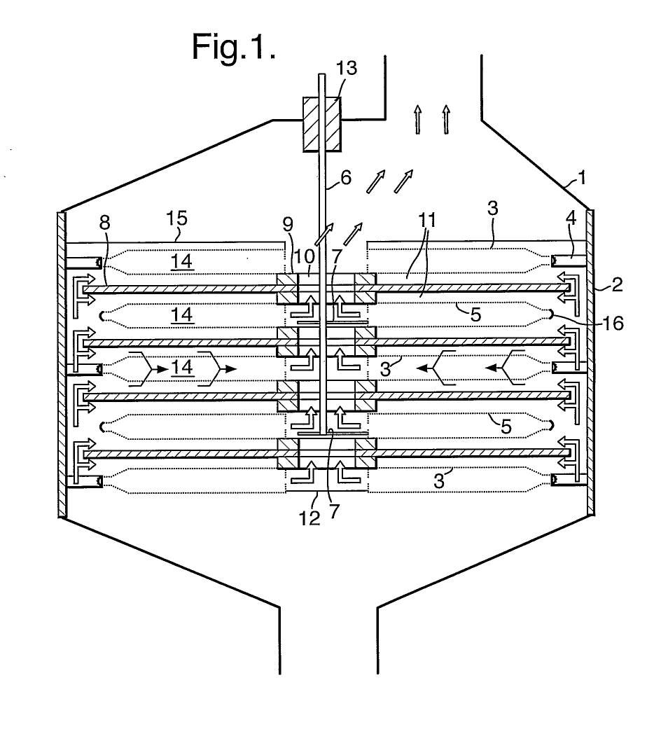

FIG. 1 is a diagrammatic cross-sectional view of a reactor according to the present invention,

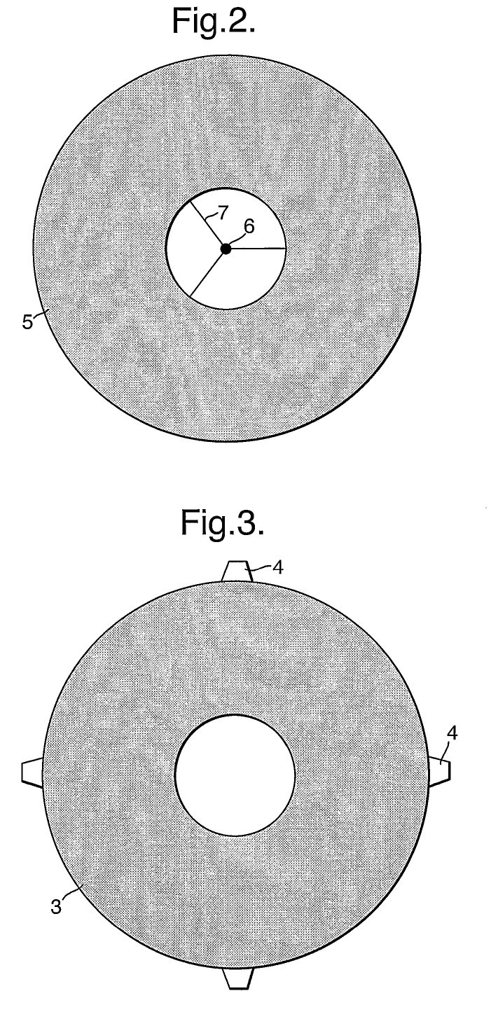

FIG. 2 is a diagrammatic plan view of a filter 5 as shown in FIG. 1,

FIG. 3 is a diagrammatic plan view of a filter 3 as shown in FIG. 1,

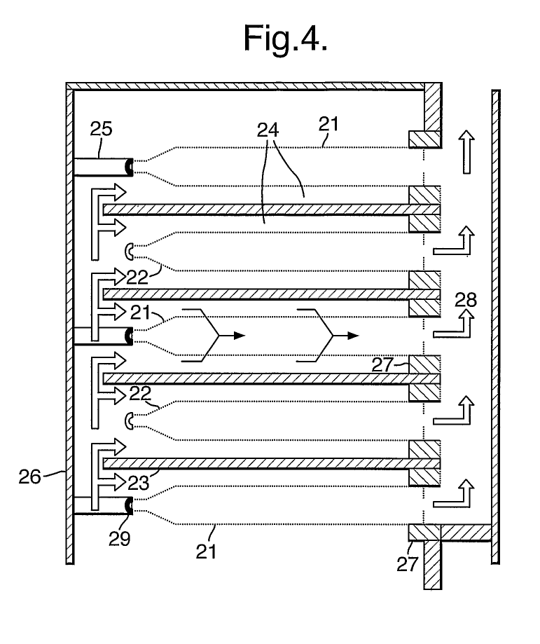

FIG. 4 is a diagrammatic cross-sectional view of a reactor according to the present invention,

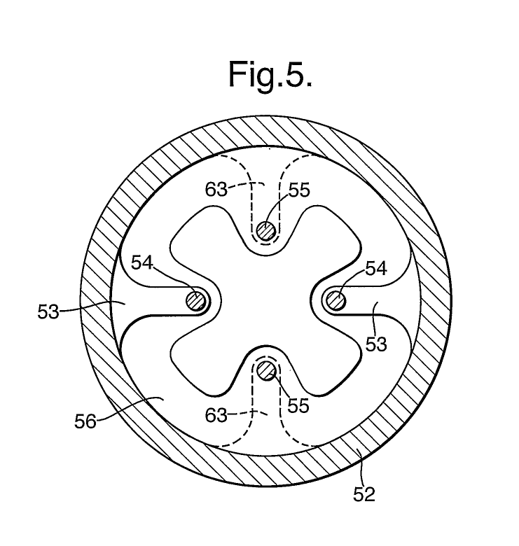

FIG. 5 is a plan view of the hub of an annular filter as used in the present invention, and

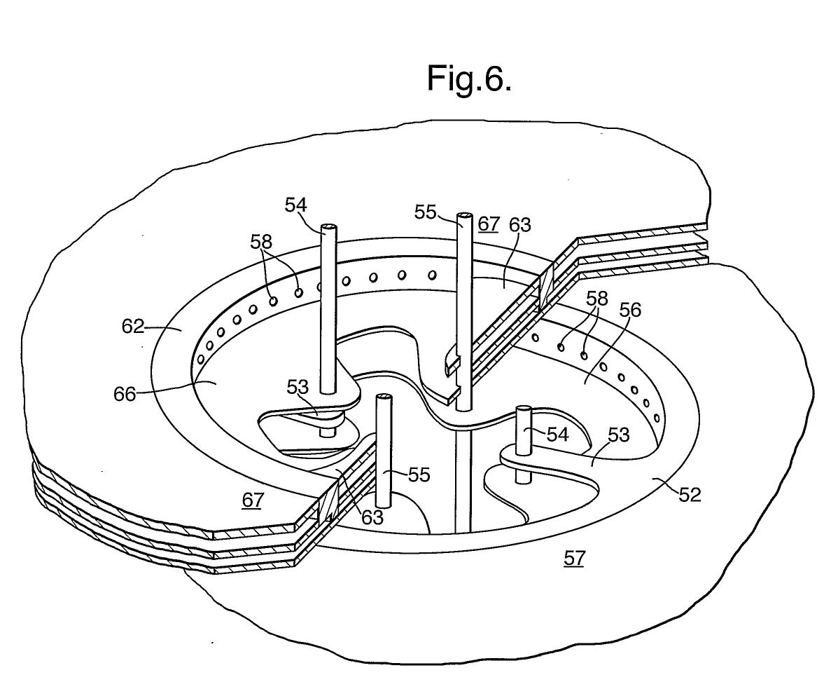

FIG. 6 is a diagrammatic cut-away view of the hub of the annular filter as shown in FIG. 5.

FIG. 1 shows a reactor according to a preferred embodiment of the present invention where the double-sided filter elements 3 and 5 are in the form of annular discs. The reactor comprises an outer conducting can 1 which acts as the earth connection 2 for those filter elements 3 which are connected to earth. The reactor comprises twenty-one, thirty-one or more filter elements as necessary of which only five filter elements 3,5 are shown and are connected to earth and high voltage respectively. The filter elements 3 are connected to the outer can of the reactor 2 by tabs 4 at points around the circumference of the filter elements. The intervening filter elements 5 are connected to a high voltage connection 6 by spokes 7 in the centre of the reactor. A dielectric barrier 8 is positioned between each successive filter element 3,5. The dielectric barriers 8, filters 3 and 5 and the annuli 9 of dielectric material together define a central cylindrical space 10 in the centre of the reactor. In another embodiment of the present invention each dielectric barrier 8 and the adjacent annuli 9 may together form a single component (not shown). Gas flowing into the reactor follows the path shown by the arrows in FIG. 1. The gas passes around the outer edges of the filter elements 3,5 and the dielectric barriers 8 and into the spaces 11 between the filter elements 3,5 and the dielectric barriers 8. Plasma is formed in the space 11 during operation of the reactor. Any particulates in the gas are trapped on the filter surfaces where they can be remediated by the plasma. The gas passes into the space 14 inside the filter elements 3,5. From the space 14 the gas flows into the central space 10 in the centre of the reactor and then leaves the reactor in the direction of the arrows. The structures 12 and 15 (shown schematically) form barriers at either end of the reactor and constrain the gas to flow through the filter elements when passing through the reactor. The high voltage connection 6 is insulated from the reactor can 1 by the insulating structure 13.

The distance between the end 16 of the filters 5 connected to high voltage and the can of the reactor 2 is such that an arc discharge does not form across this space.

FIG. 2 shows a plan view of a filter 5 as shown in the reactor of FIG. 1. The filter 5 is annular in shape. The filter is connected to a high voltage supply via the spokes 7 and conductor 6 in the centre of the annulus.

FIG. 3 shows a plan view of a filter 3 connected to earth as shown in the reactor of FIG. 1. The connection to earth is made via tabs 4 which are connected to the outer can of the reactor (not shown).

FIG. 4 shows another embodiment of the present invention where the filter elements 21,22 are in the form of flat plates which may be square, rectangular or in the shape of another polygon regular or irregular. FIG. 4 shows a cross-section through the reactor. The reactor comprises five filter elements 21,22. Three of the filter elements 21 are connected to the outer can of the reactor 26, which is earthed, by tabs 25 attached to one side of the filter. The remaining two filter elements 22 are connected to a high voltage connection (not shown) through the channel 28. Each filter element is separated from the next by a dielectric barrier 23. The dielectric barriers 23, insulating blocks 27 and the filter elements 21,22 make up the side of the reactor shown on the right hand side of the Figure. Gas passing into the reactor follows the path shown by the arrows and passes round the ends of the filter elements and into the space 24 between the filters elements 21,22 and the dielectric barriers 23. Plasma forms in the space 24 when the reactor is in use. The gas passes into the filter elements and then leaves the reactor through channel 28.

It will be appreciated that FIGS. 1 and 4 only show two examples of a reactor according to the present invention. The reactors may contain more or fewer filter elements. The reactors shown in FIGS. 1 and 4 show the top and bottom filter elements connected to earth. However, the top and/or bottom filter elements may be connected to high voltage if required though this will typically require a large distance between the filter element and the can of the reactor or any adjacent conductor so as to prevent arc discharges from occurring.

The distance between the edge of the filter elements 16,22 connected to high voltage and the outer can connected to earth is such that an arc discharge does not occur across the gap. The necessary gap is typically in the range of 1 inch (0.0254 m) per 10 kV of applied voltage in air.

An alternative way to make electrical connections to the filter elements 3 and 5 is shown in FIGS. 5 and 6, to which reference is now made.

FIG. 5 shows the hub 52 of an annular filter element (not shown in FIG. 5). The hub 52 incorporates two inwardly projecting conducting tabs 53. The filter element is separated from the next filter element in the stack by an insulating dielectric plate 56. Rods 54 and 55 pass through the dielectric plate 56. The rods 54 also pass through the tabs 53, and provide an electrical connection to the tabs. The rods 54 are connected to a high voltage supply (not shown), for example at one end of the stack. An adjacent filter element can be connected through further projecting conducting tabs 63 to rods 55 which are at earth potential. Thus alternate filter elements are at high voltage and earth potential.

FIG. 6 shows a cut-away perspective view of the hubs 52,62 of two adjacent filter elements 57,67. The hubs 52,62 are perforated by radial holes 58. The lower filter element 57 has a hub 52 with inwardly projecting conducting tabs 53 connected to the rods 54. The upper filter element 67 has a hub 62 with tabs 63 connected to the rods 55. A dielectric plate 66 insulates the hubs 52 and 62 from one another and extends beyond the outer diameter of the filter elements 57,67. Below the hub 52 is a further dielectric layer 56. This arrangement can be repeated to form a larger stack of filter elements. The rods 54 are connected to high voltage and the rods 55 are connected to earth or vice versa.

In use the exhaust gases enter the filter elements 57,67 in a similar way to that described above in relation to FIG. 1, and the filtered exhaust gas enters the hub 52,62 of the reactor through radial holes 58. The exhaust gases then flow along the stack in the hubs so as to leave the reactor.

1. A non-thermal plasma reactor for the treatment of a gaseous medium comprising
a plurality of double-sided filter elements in a stack, the elements acting as electrodes of the reactor and being connectable alternately to high voltage and earth, and
provided with a dielectric barrier between successive filter elements
wherein the gaseous medium is constrained to flow into the filter elements through both sides thereof.

2. A reactor according to claim 1 wherein the filter elements are annular.

3. A reactor according to claim 1 wherein the filter elements are hollow.

4. A vehicle, ship or power generation unit comprising a reactor according to claim 1.

5. A method for treating a gaseous medium to remove particulates comprising passing the gaseous medium through a reactor according to claim 1 and generating a plasma in the reactor intermittently or continuously.

6. Use of a reactor according to claim 1 for the removal of particulates from a gaseous medium.
